(19) United States
(12) Patent Application Publication
(10) Pub. No.: US 2018/0006840 A1
(43) Pub. Date: Jan. 4, 2018

(54) WEARABLE DEVICE AND CONTROLLING METHOD THEREOF, AND SYSTEM FOR CONTROLLING SMART HOME

(71) Applicant: Goertek Inc., Weifang City, Shandong (CN)

(72) Inventors: Pengcheng SU, Weifang City, Shandong (CN); Fuli XIE, Weifang City, Shandong (CN)

(21) Appl. No.: 15/540,808

(22) PCT Filed: Sep. 5, 2016
(86) PCT No.: PCT/CN2016/098082

§ 371 Date: Jun. 29, 2017

(30) Foreign Application Priority Data
Dec. 31, 2015 (CN) 201511031455.0

(51) Int. Cl. H04L 12/28; G06F 3/01

(52) U.S. Cl. CPC H04L 12/2816; H04L 12/2807; G06F 3/017; H04L 2012/285; H04L 2012/2841

(57) ABSTRACT

A wearable device and a controlling method thereof, and a system for controlling a smart home. The wearable device comprises: a hand gesture identifying module, for by characteristic data to be identified of a wearer that is collected by a sensor, identifying out a current hand gesture action of the wearer; an appliance configuring module, for according to acquired information of each of household electrical appliances, establishing and saving correspondence relations between controlling commands of each of the household electrical appliances and corresponding hand gesture actions; and upon receiving the hand gesture action, looking up the household electrical appliance and the controlling command that match the hand gesture action by using the correspondence relations, generating a controlling message according to the matched information; a wirelessly connecting module, for receiving the controlling message and wirelessly sending the controlling message to a smart home controlling server.

### TECHNICAL FIELD

The present disclosure relates to the technical field of smart home and specifically to a wearable device and a controlling method thereof, and a system for controlling a smart home.

### BACKGROUND

Currently, with technological advances and the growth in the living standard, the technology of smart home has rapidly developed. The technology, by using advanced computer technology, embedded technology, network communication technology and so on, actively links various subsystems that are relevant to home life (such as smart household electrical appliance controlling, smart light controlling and smart safeguard), and the subsystems are coordinated and controlled in a centralized way by a home controlling center. However, in the conventional solutions of smart home controlling, the controlling modes generally employ the conventional key-pressing or touching modes, the operations are relatively tedious, the level of intelligentization is relatively low, and the user experience is relatively poor.

### SUMMARY

The present disclosure provides a wearable device and the controlling method thereof, and a system for controlling a smart home, to solve the problem that the controlling modes of the controlling themes of the conventional smart household electrical appliances are tedious, which results in poor user experience.

According to an aspect of the present disclosure, there is provided a wearable device, and the wearable device comprises: a hand gesture identifying module, a wirelessly connecting module and an appliance configuring module;

the hand gesture identifying module is for by characteristic data to be identified of a wearer that is obtained by a sensor by collecting, identifying out a current hand gesture action of the wearer, and sending the hand gesture action to the appliance configuring module;

the appliance configuring module is for according to acquired information of each of household electrical appliances, establishing and saving correspondence relations between controlling commands of each of the household electrical appliances and corresponding hand gesture actions; and, for upon receiving the hand gesture action that is sent by the hand gesture identifying module, looking up the household electrical appliance and the controlling command that match the hand gesture action by using the saved correspondence relations, generating a controlling message according to the matched household electrical appliance and controlling command, and sending the generated controlling message to the wirelessly connecting module; and

the wirelessly connecting module is for receiving the controlling message that is sent by the appliance configuring module and wirelessly sending the controlling message to a smart home controlling server, so that the smart home controlling server controls the condition of the household electrical appliance according to the controlling message.

According to another aspect of the present disclosure, there is provided a system for controlling a smart home, and the system for controlling a smart home comprises: the wearable device according to an aspect of the present disclosure, a smart home controlling server, and, a plurality of household electrical appliances that are wirelessly connected with the smart home controlling server;

the wearable device on the basis of a hand gesture action of the user sends a controlling command to the smart home controlling server, and the smart home controlling server sends the controlling command to each of the household electrical appliances by the wireless connection, thereby realizing the controlling on each of the household electrical appliances.

According to still another aspect of the present disclosure, there is provided a method for controlling a wearable device, wherein the wearable device is provided with a sensor, and the method comprises:

collecting characteristic data to be identified of a wearer by the sensor, and identifying out a current hand gesture action of the wearer;

by using correspondence relations that are in advance saved between corresponding hand gesture actions and controlling commands of household electrical appliances, matching the current hand gesture action, and generating a controlling message according to matched household electrical appliance information and the controlling command; and

wirelessly sending the generated controlling message to a smart home controlling server, so that the smart home controlling server controls the condition of the household electrical appliance according to the controlling message.

The advantageous effect of the present disclosure is: the wearable device of the embodiments of the present disclosure can collect the hand gesture data of the wearer by the built-in sensor, identify out the hand gesture action, and control the condition of the corresponding household electrical appliance by the hand gesture action, thereby realizing that: firstly, the wearer is merely required to perform the corresponding hand gesture action (for example, drawing a circle) to perform convenient and intuitive controlling on different smart household electrical appliances, which avoids the relatively tedious controlling modes caused by remote controller, smart phone and other terminal devices; and secondly, the wearable device is generally worn on the user for a long time, and accordingly the wearer can control the smart household electrical appliances by executing certain hand gesture actions at any time, and, compared with the traditional controlling modes, the present disclosure does not need to look for the control terminal, which saves the time, promotes the efficiency, and enhances the user experience.

### BRIEF DESCRIPTION OF DRAWINGS

FIG. 1 is the structural block diagram of the wearable device of an embodiment of the present disclosure;

FIG. 2 is the structural block diagram of the smart watch of another embodiment of the present disclosure;

FIG. 3 is the schematic flow chart of the hand gesture identification of an embodiment of the present disclosure;

FIG. 4 is the work flow chart of the smart watch of an embodiment of the present disclosure;

FIG. 5 is the structural block diagram of the smart home controlling server of a further embodiment of the present disclosure;

FIG. 6 is the work flow chart of the smart home controlling server of an embodiment of the present disclosure;

FIG. 7 is the network structure diagram of the system for controlling a smart home of an embodiment of the present disclosure; and

FIG. 8 is the structural block diagram of the system for controlling a smart home of an embodiment of the present disclosure.

### DETAILED DESCRIPTION

The core concept of the present disclosure is: regarding the problem that the operations are tedious and the user experience is poor in the controlling modes of the conventional smart homes, the present disclosure provides a wearable device (for example a smart watch), wherein various types of MEMS (Micro-Electro-Mechanical System) sensors are embedded in the smart watch, such as an accelerometer and a gyroscope, to provide software and hardware support to hand gesture identification on the basis of sensors. In addition, in consideration that the smart watch is generally worn on the wrist of the user for a long time, by using the smart watch as the controller of the smart household electrical appliances, the wearer is merely required to perform certain hand gesture actions to give different controlling commands, so as to control the condition of the household electrical appliances, which more conveniently and intuitively realizes the interaction between the wearer and the household electrical appliances, and enhances the user experience.

### The First Embodiment

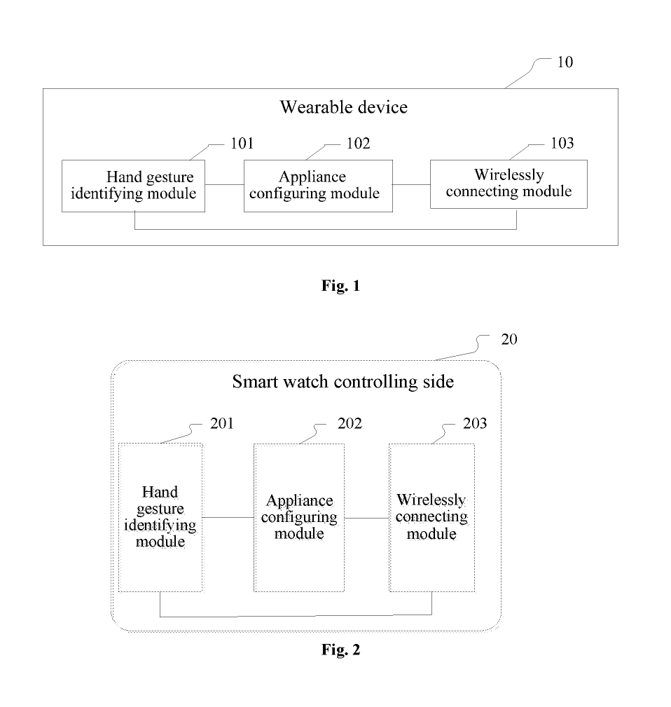

FIG. 1 is the structural block diagram of the wearable device of an embodiment of the present disclosure. Referring to FIG. 1, the wearable device 10 comprises:

a hand gesture identifying module 101, for by characteristic data to be identified of a wearer that is obtained by a sensor by collecting, identifying out a current hand gesture action of the wearer, and sending information of the hand gesture action to an appliance configuring module 102;

the appliance configuring module 102, for according to acquired information of each of household electrical appliances, establishing and saving correspondence relations between controlling commands of each of the household electrical appliances and corresponding hand gesture actions; and, for upon receiving the information of the hand gesture action that is sent by the hand gesture identifying module 101, looking up the household electrical appliance and the controlling command that match the hand gesture action by using the saved correspondence relations, generating a controlling message according to the matched household electrical appliance and controlling command, and sending the generated controlling message to a wirelessly connecting module 103; and

the wirelessly connecting module 103, for receiving the controlling message that is sent by the appliance configuring module 102 and wirelessly sending the controlling message to a smart home controlling server, so that the smart home controlling server controls the condition of the household electrical appliance according to the controlling message.

In the present embodiment, the appliance configuring module 103 is provided with information of a default hand gesture action; the appliance configuring module 103 is specifically for establishing and saving correspondence relations between the controlling commands of each of the household electrical appliances and the default hand gesture actions; or, the appliance configuring module 103 is for receiving an optional hand gesture action that is inputted by the wearer by the interaction interface of the wearable device, and establishing and saving correspondence relations between the controlling commands of each of the household electrical appliances and the optional hand gesture actions.

By the wearable device shown in FIG. 1, the method realizes the connecting and the controlling with the smart household electrical appliances. When the wearer gives a certain hand gesture action, the wearable device can automatically detect that and send a corresponding controlling command to the control center of the smart home, and in turn control the condition of the corresponding household electrical appliance, which realizes the advantageous effect of conveniently and intuitively interacting with the household electrical appliance.

Additionally, to realize the controlling on a smart home by wearable devices such as smart watch, the following technical difficulties must be overcome:

(1) The hand gesture identification on the basis of wearable devices is required to take the calculation amount and power consumption into account. Wearable devices such as smart watches are devices with limited resources, and in the process of hand gesture identification, a sustained perception on actions needs to consume considerable energy. Therefore, further effective solutions are needed, to ensure the reliability of the hand gesture action identification while reducing the complexity of the algorithms and reducing the calculation amount;

(2) How to individually access corresponding household electrical appliances by different hand gesture actions, and control the corresponding household electrical appliances; and

(3) The solutions are required to solve the security problem of controlling the smart home by using hand gesture identification, to prevent strangers from controlling the household electrical appliances by using the same wearable device.

By referring to other embodiments of the present disclosure below, the technical means that the technical solutions of the present disclosure employ to overcome the above technical difficulties are specifically described.

### The Second Embodiment

FIG. 2 is the structural block diagram of the smart watch of an embodiment of the present disclosure. The present embodiment mainly describes the structure of the smart watch, and the other contents can be seen in the other embodiments of the present disclosure.

When controlling different household electrical appliances by using the smart watch for the first time, the embodiment firstly establishes a connection between the smart watch and a smart home controlling server by a wireless mode such as BLE (Bluetooth Low Energy), and then controls different household electrical appliances that are connected with the smart home controlling server. More specially, the smart watch establishes the correspondence relations between optional hand gesture actions or default hand gesture actions and the controlling commands of the household electrical appliances. The optional hand gesture actions may be customized by the wearer in a household electrical appliance configuring interface of the smart watch. The default hand gesture actions are those hand gesture actions that are saved in the smart watch in advance and do not require the user to design by themselves.

In the present embodiment, a smart watch controlling side 20 (which is provided within the smart watch) comprises: a hand gesture identifying module 201, an appliance configuring module 202 and a wirelessly connecting module 203.

During the process of particular application, the wearer performs a certain hand gesture action, and the hand gesture identifying module 201, after identifying out the hand gesture action, inquires out the household electrical appliance and the controlling command that are corresponding to the hand gesture action from the correspondence relations that are in advance saved between the corresponding hand gesture actions and the household electrical appliances and the controlling commands, and combines the unique identification ID of the household electrical appliance and the controlling command information to form a controlling message, and the wirelessly connecting module 203 sends the controlling message to the smart home controlling server in the wireless mode of Bluetooth Low Energy BLE. The functions of each of the modules of the smart watch controlling side are described below by referring to FIG. 2 as follows:

Hand Gesture Identifying Module 201

The module is mainly for establishing a hand gesture template and executing the function of user hand gesture identification, thereby providing the user with a natural and intuitive hand gesture controlling mode. The module collects the hand gesture data of the wearer and performs hand gesture identification by using a MEMS sensor.

The First Function: The Establishing of a Hand Gesture Template

The present embodiment, when establishing a hand gesture action template, considers the following two factors: the first is that the hand gestures should be as simple as possible, so that the user can quite easily learn and use them; and the second is that the hand gestures should be easily identified and distinguished. Because the present embodiment is mainly used for controlling household electrical appliances such as electric lamp, television set and air conditioner, some default hand gestures are designed in advance according to the characteristics of those household electrical appliances and saved. Referring to the following Table 1, Table 1 is a table of the correspondence relations between the hand gesture actions and the controlling commands of different types of household electrical appliances.

TABLE 1

| Hand gesture | | Corresponding |
|---|---|---|
| actions | Descriptions | controlling commands |
| 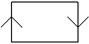 | Drawing a rectangle in a clockwise direction | Turning on the television set |
| 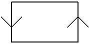 | Drawing a rectangle in a counter-clockwise direction | Turning off the television set |
| 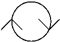 | Drawing a circle in a clockwise direction | Turning on the electric lamp |
| 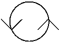 | Drawing a circle in a counter-clockwise direction | Turning off the electric lamp |
| 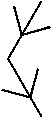 | Drawing a broken line in a top-to-bottom direction | Turning on the air conditioner |
| 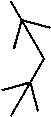 | Drawing a broken line in a bottom-to-top direction | Turning off the air conditioner |

In Table 1, the embodiment defines corresponding a hand gesture action of drawing a rectangle in the clockwise direction and a hand gesture action of drawing a rectangle in the counter-clockwise direction respectively to a turning-on controlling command and a turning-off controlling command of the household electrical appliance of a first type (such as a television set); corresponding a hand gesture action of drawing a circle in the clockwise direction and a hand gesture action of drawing a circle in the counter-clockwise direction respectively to a turning-on controlling command and a turning-off controlling command of the household electrical appliances of a second type (such as an electric lamp); and corresponding a hand gesture action of drawing a broken line in the top-to-bottom direction and a hand gesture action of drawing a broken line in the bottom-to-top direction respectively to a turning-on controlling command and a turning-off controlling command of the household electrical appliance of a third type (such as an air conditioner).

It should be noted that, Table 1 merely schematically shows some default hand gesture actions, and in practical applications the embodiment may also provide an interaction interface when the appliance configuring module specifically configures the correspondence relations between the household electrical appliances and the hand gesture actions so that the user can customize the hand gesture actions.

The second function: hand gesture identification.

In order to satisfy the requirements of wearable devices such as the smart watch on resource and power consumption, in the present embodiment, after collecting the characteristic data to be identified by using the MEMS sensor, the embodiment firstly reduces the data dimension number by using PCA (Principal Components Analysis) algorithm.

By using the principal components analysis, the embodiment can decide the importance of each of the independent components according to the sizes of the characteristic values in the calculating process, choose the most important component, and lower the original characteristic data to be identified to one dimension, which can remove part of the noise while reducing the calculation complexity, and reduce the requirements on the gesture when the user is executing the hand gesture actions. Then, the embodiment further performs an identifying algorithm (such as template matching algorithm or machine learning algorithm) on the data of which the dimension has been reduced, which realizes precise hand gesture identification while reducing the calculation complexity.

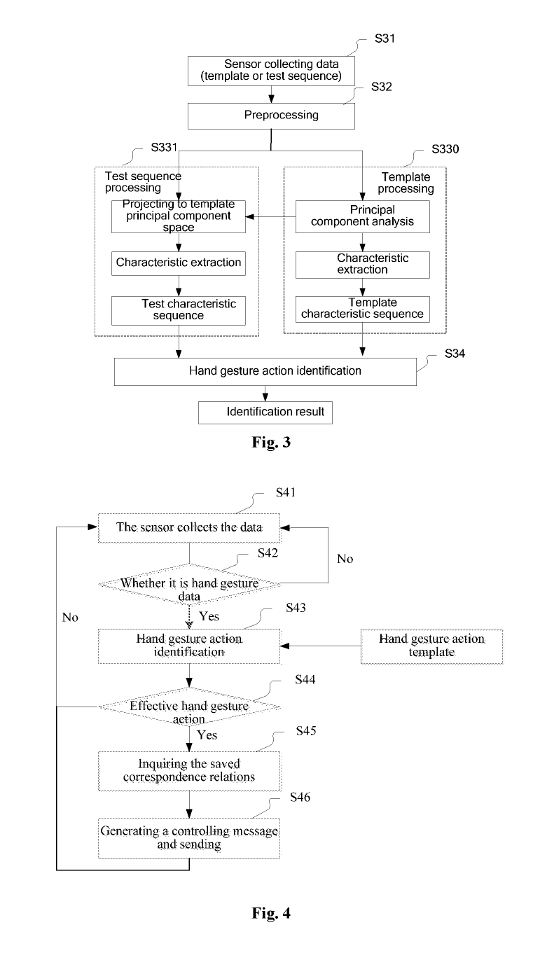

FIG. 3 is the schematic flow chart of the hand gesture identification of an embodiment of the present disclosure. Referring to FIG. 3, the hand gesture identification that is on the basis of a three-axis acceleration sensor (or a three-axis angular velocity sensor) comprises the processing procedures such as preprocessing, principal components analysis processing, characteristic extraction, and hand gesture matching. In order to reduce the calculation amount, the present embodiment employs the PCA method to lower the three-dimensional acceleration data to one dimension and then performs processings such as matching and identifying. The specific processing procedure of the hand gesture template and the test sequence is as follows:

Step S31, collecting data by a three-axis acceleration sensor, to obtain a three-dimensional acceleration template sequence (or a three-dimensional acceleration test sequence); and entering Step S32.

Step S32, preprocessing: preprocessing the three-dimensional acceleration sensor data that are collected, which can employ processing methods such as mean filtering and Butterworth filtering, to filter out interfering noise; and if a template sequence is collected, entering Step S330, and if a test sequence is collected, entering Step S331.

Step S330, for the template sequence, performing PCA processing on the three-dimensional acceleration sequence, to obtain characteristic vector space of the principal component, performing characteristic extraction to reduce dimension (such as the mean or variance of neighboring data points, or directly extracting the waveform change characteristic) on the template sequence, to obtain a one dimension template characteristic sequence, and entering Step S34.

Step S331, for the test sequence, projecting the three-dimensional acceleration sequence to the principal component characteristic vector space of the template sequence, performing characteristic extraction to obtain a one dimension test characteristic sequence, and entering Step S34.

Step S34, hand gesture action identification.

After obtaining the characteristic sequence of the template sequence or the test sequence, matching the test characteristic sequence with each of the template characteristic sequences (for example, identifying by using template matching or machine learning method matching), to obtain an identification result, wherein, the template characteristic sequences can be saved in a template library for hand gesture action identifying and matching.

More detailed calculating process of the hand gesture action identification in Step S34 can be seen in the relevant contents of principal components analysis of the prior art, and will not be in detail described in the present embodiment.

It should be noted that, although the present embodiment employs principal components analysis to perform characteristic extraction and data dimension reduction on the collected original acceleration signal, the method is not limited thereto, and in other embodiments can also employ other methods and means of dimension reduction.

Appliance Configuring Module 202

The appliance configuring module is for establishing the connection between the controlling on the smart household electrical appliances that are to be controlled and the hand gesture actions of the user, so that the user can wear the smart watch and control the smart household electrical appliances by hand gesture. One way of implementing the registering is that, the smart watch establishes the connection with the smart home controlling server by BLE and logs in, when executing the configuring operation, acquires from the smart home controlling server by the wirelessly connecting module an information list of all the household electrical appliances that are connected with the smart home controlling server, and presents the list on the interaction interface of the smart watch, which facilitates the wearer logging in on the configuring interface at any time to modify the relevant household electrical appliances and hand gestures. For example, the embodiment, by the appliance configuring module, receives an instruction of adding or deleting a household electrical appliance that is selected by the wearer in a household electrical appliance information list that is presented on the interaction interface of the smart watch, and establishes and saves a correspondence relation between the controlling command of the added household electrical appliance and a hand gesture action according to the adding instruction of the wearer; or, releases a correspondence relation between the controlling command of the deleted household electrical appliance and the hand gesture action and save according to a deleting instruction of the wearer.

The present embodiment presents the household electrical appliance list on the interaction interface of the smart watch, receives the household electrical appliance that is intended to be controlled by hand gesture and selected by the user from the household electrical appliance list, and then on the basis of this adding operation of the user, establishes the hand gesture action that is corresponding to the controlling command of the added household electrical appliance, or receives the operation, that is inputted by the user on the interaction interface of the smart watch, of deleting a certain household electrical appliance from the household electrical appliance list that has already been controlled by hand gesture, and on the basis of this deleting operation of the user, releases the correspondence relation between the controlling command of the household electrical appliance that is corresponding to the deleting operation and the hand gesture action. Accordingly, on one hand, the embodiment is more personalized, enhances the sense of participation of the user, and optimizes the user usage experience. On the other hand, each of the hand gesture actions can be repeatedly used to control a plurality of household electrical appliances. For example, if the user frequently uses a certain household electrical appliance during a period of time, the user can by the adding operation add the household electrical appliance into the household electrical appliance list to perform hand gesture controlling, and, if subsequently he no longer frequently uses the household electrical appliance, can delete the household electrical appliance and release the correspondence relation between the household electrical appliance and the hand gesture action. Accordingly, the same hand gesture action can be repeatedly used, which avoids designing different hand gesture actions too much times.

The embodiment associates the controlling commands of different household electrical appliances with the corresponding hand gestures (default hand gesture actions or optional hand gesture actions), and then saves the configuring information of the household electrical appliances to facilitate the subsequent looking up and matching of the hand gesture actions.

After the configuring is successfully completed, the smart watch can realize the controlling on the conditions of the household electrical appliances by the preset different hand gesture actions and the corresponding controlling commands of the household electrical appliances.

Wirelessly Connecting Module 203

The wirelessly connecting module 203 is mainly for performing wireless communication with the smart home controlling server.

In order to ensure the security of utilizing the smart watch and the hand gesture actions to control the smart household electrical appliances, when controlling by using the smart watch for the first time, after establishing the BLE connection with the smart home controlling server, the wirelessly connecting module in the smart watch sends the registration information of the smart watch and the identity information of the wearer to the smart home controlling server, and the smart home controlling server verifies the smart watch and the wearer, and after the verification is passed, completes the registering of the smart watch and the wearer. By verifying the smart watch and the identity information of the wearer, the embodiment prevents strangers from controlling the household electrical appliances by using the same wearable device, which ensures the security of controlling the smart household electrical appliances by using the hand gesture actions.

In order to facilitate the user operation, after the verification is successfully completed, when the smart watch is connected with the smart home controlling server by BLE again, the smart watch can merely send the logging-in information to the smart home controlling server, to realize automatic logging-in, without requiring verification again.

In other embodiments of the present disclosure, in order to further ensure the security, the smart watch can also verify the smart home controlling server, that is, two-way verification. The smart watch acquires the registration information of the smart home controlling server and saves, and during the process of the subsequent usage, the wirelessly connecting module of the smart watch merely sends a logging-in request to a smart home controlling server that has been registered. The smart home controlling server acquires the registration information of the smart watch and the wearer of the smart watch and saves, and the smart home controlling server merely accepts the controlling commands of the smart watch and the wearer that have been registered. Accordingly, the method prevents a user that has not been verified controlling the household electrical appliances by using a smart watch, which ensures the security of controlling the household electrical appliances by the smart watch.

In the present embodiment, the wirelessly connecting module 203, after receiving the controlling message, sent by the appliance configuring module 202, that contains the unique identification ID of the household electrical appliance and the controlling command that are corresponding to the hand gesture action, sends this controlling message to the smart home controlling server, and the smart home controlling server realizes the controlling on the condition of the designated household electrical appliance according to the controlling message.

In addition, the wirelessly connecting module 203 is further for receiving the feedback information (for example, information such as whether the controlling is successful or not and the current condition of the controlled household electrical appliance) that is sent by the smart home controlling server, and sending the feedback information to the appliance configuring module of the smart watch, so that the appliance configuring module controls to output corresponding reminder information to the wearer.

FIG. 4 is the work flow chart of the smart watch of an embodiment of the present disclosure. Referring to FIG. 4, a control procedure of the smart watch comprises the following Step S41 to Step S46:

Step S41, collecting data by the sensor, and then entering Step S42.

The embodiment collects characteristic data to be identified of a wearer by the sensor, wherein the sensor comprises an acceleration sensor and an angular velocity sensor (for example gyroscope), and obtains a three-axis acceleration data sequence or a three-axis angular velocity data sequence that is to be identified of the wearer by collecting by using a three-axis acceleration sensor or a three-axis angular velocity sensor.

Step S42, judging whether it is hand gesture data, and if yes, executing Step S43, and if no, returning to execute Step S41.

Specially, taking the acceleration sensor as an example, after a three-axis acceleration data signal is collected, the embodiment firstly performs data dimension reduction processing on the three-axis acceleration data signal, to lower to one dimension, thereby reducing the calculation complexity and reducing the noise, and then performs template matching on the one dimension acceleration signal, to determine whether the acceleration signal that is collected this time is a hand gesture action. Because during the process of practical applications, the wearer may possibly have misoperations, it is required to judge whether it is hand gesture data, and if it is not hand gesture data, the following processing steps may be not performed, to save power, and ensure the accuracy of the controlling.

Step S43, hand gesture action identification: performing hand gesture action identification by using the saved hand gesture action template, and then entering Step S44.

By using correspondence relations that are in advance saved between the hand gesture action templates and the corresponding hand gesture actions and the controlling commands of the household electrical appliances, the embodiment matches the current hand gesture action, and generates a controlling message according to information of a matched household electrical appliance and the controlling command. Specially, in the present step it is required to match the hand gesture data sequence of Step S42 and the hand gesture action sequence in the hand gesture action template that is saved in advance, to determine the type of the hand gesture action. The corresponding hand gesture action comprises: a default hand gesture action and an optional hand gesture action; the smart watch may set the correspondence relations between the default hand gesture actions and the controlling commands of the household electrical appliances by the following way: corresponding a hand gesture action of drawing a rectangle in the clockwise direction and a hand gesture action of drawing a rectangle in the counter-clockwise direction respectively to a turning-on controlling command and a turning-off controlling command of the household electrical appliance of a first type; corresponding a hand gesture action of drawing a circle in the clockwise direction and a hand gesture action of drawing a circle in the counter-clockwise direction respectively to a turning-on controlling command and a turning-off controlling command of the household electrical appliance of a second type; and corresponding a hand gesture action of drawing a broken line in the top-to-bottom direction and a hand gesture action of drawing a broken line in the bottom-to-top direction respectively to a turning-on controlling command and a turning-off controlling command of the household electrical appliance of a third type. Further, the correspondence relation between the optional hand gesture actions and the controlling commands of the household electrical appliances is set by the following way: receiving an optional hand gesture action that is inputted by the user on an interaction interface of the wearable device, and establishing a correspondence relation between the optional hand gesture action and a controlling command of the household electrical appliances.

In other embodiments, the smart watch may also set the correspondence relation between a corresponding hand gesture action and a controlling command of the household electrical appliances by the following way: receiving an instruction of adding or deleting a household electrical appliance selected by the wearer in a household electrical appliance information list that is presented on the interaction interface of the wearable device, and establishing, according to the adding instruction of the wearer, a correspondence relation between the controlling command of the added household electrical appliance and a hand gesture action; or, according to a deleting instruction of the wearer, releasing a correspondence relation between the controlling command of the deleted household electrical appliance and the hand gesture action.

Step S44, judging whether it is an effective hand gesture action; and if yes, executing Step S45, and if no, executing Step S41.

Optionally, the present embodiment further provides the step of judging whether the hand gesture action identified is an effective hand gesture action, to further ensure the accuracy of hand gesture action controlling. Because in practical applications the user may modify the correspondence relations between the hand gesture actions and the household electrical appliances and the controlling commands by the interaction interface of the smart watch, there may be cases when the hand gesture action that is identified out on the basis of the hand gesture action template has already been outdated. For example, before the modifying, the hand gesture action that is corresponding to the controlling command of turning on the television set is drawing a circle in the clockwise direction, and in the process of subsequent usage the wearer modifies the controlling command to be that drawing a rectangle in the clockwise direction. If at this time the smart watch identifies out that the current hand gesture action of the user is drawing a circle in the clockwise direction, it determines that the hand gesture action is an ineffective hand gesture action (that is, that does not match the currently saved correspondence relations between the hand gesture actions and the household electrical appliances and the controlling commands).

Step S45, inquiring the saved correspondence relations, and then entering Step S46.

Here, the smart watch side in advance establishes the correspondence relations between the corresponding hand gesture actions and the household electrical appliances and the controlling commands of the household electrical appliances, and saves the correspondence relations into a database. After receiving information that the current hand gesture action is an effective hand gesture action as determined by Step S44, the embodiment inquires the saved correspondence relations, to thereby find the ID of the household electrical appliance and the controlling command of the household electrical appliance that are matched with the hand gesture action. Here the controlling commands comprise: the command of turning on a household electrical appliance or the command of turning off a household electrical appliance, or further comprise: the command of adjusting the corresponding condition of a household electrical appliance (for example adjusting the volume of a smart television set), which is not limited.

Step S46, generating a controlling message and sending.

the embodiment wirelessly sends the generated controlling message to a smart home controlling server, so that the smart home controlling server controls the condition of the household electrical appliance according to the controlling message. Specially, after obtaining the ID of the household electrical appliance and the controlling command, the embodiment generates a controlling message according to the household electrical appliance ID and the controlling command, and sends the controlling message to the wirelessly connecting module, and the wirelessly connecting module sends to the smart home controlling server, by which the wearer of the smart watch completes the household electrical appliance controlling once. Then the embodiment returns, to repeatedly execute Step S41 to Step S46. Upon connecting to the smart home controlling server for the first time, the embodiment sends registration information of the wearable device and identity information of the wearer to the smart home controlling server, so that the smart home controlling server verifies the wearable device and the wearer; and

upon, after the verification is successfully completed, connecting to the smart home controlling server again, sends logging-in information to the smart home controlling server.

### The Third Embodiment

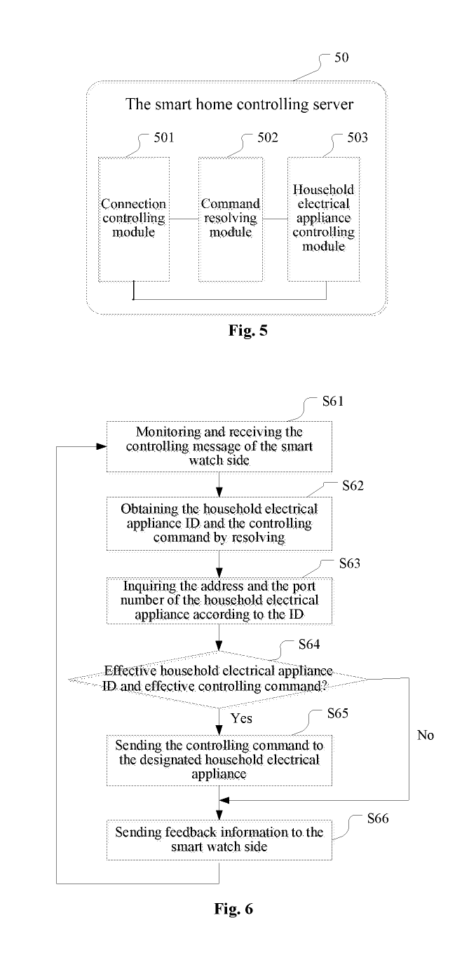

FIG. 5 is the structural block diagram of the smart home controlling server of an embodiment of the present disclosure. The present embodiment mainly describes the structure of the smart home controlling server, and the other contents can be seen in the other embodiments of the present disclosure.

In the present embodiment, the smart home controlling server 50 comprises three modules, which are a connection controlling module 501, a command resolving module 502, and a household electrical appliance controlling module 503. The smart home controlling server 50 monitors and receives the controlling message that is sent by the smart watch controlling side, resolves out the household electrical appliance ID and the corresponding controlling command from the controlling message, inquires out the corresponding network address and the port number of the appliance in the household electrical appliance information list that is in advance saved according to the household electrical appliance ID, and then sends the controlling command to the household electrical appliance that is corresponding to the network address and the port number, thereby realizing the advantageous effect of controlling the conditions of household electrical appliances according to the hand gesture actions of the wearer of the smart watch. In addition, in other embodiments, the smart home controlling server 50 may also send relevant feedback information to the smart watch side, so that the smart watch side can output reminder information to the user, to prompt the user to in time know the execution result regarding the hand gesture action.

Each of the modules of the smart home controlling server 50 is described below by referring to FIG. 5:

Connection Controlling Module 501

The module is for establishing a wireless connection with the wirelessly connecting module of the smart watch, and receiving and sending communication data, and the functions specifically comprise: establishing a wireless connection, such as Bluetooth Low Energy BLE, with the smart watch; and when controlling the household electrical appliances by using the smart watch for the first time, verifying the smart watch, and completing the registering of the smart watch.

Specially, the connection controlling module 501, after establishing a wireless connection with the smart watch for the first time, receives the registration information of the smart watch and the identity information of the wearer that are sent by the smart watch, verifies the registration information and the identity information, when the verification is passed, returns a logging-in page to the smart watch, and receives the logging-in information that is sent by the smart watch.

After the identity verification, the connection controlling module monitors the connection request of the smart watch, may further receive the controlling message of the household electrical appliance that is sent by the smart watch, and send to the command resolving module 502 to be processed; and sends the relevant feedback information to the smart watch controlling side.

Command Resolving Module 502

The module is mainly for receiving the controlling message from the connection controlling module 501, resolving the received controlling message, acquiring the household electrical appliance ID and the controlling command information in the controlling message, and then transmitting this information to the household electrical appliance controlling module 503 to be further processed.

Household Electrical Appliance Controlling Module 503

The module, according to the household electrical appliance ID that is obtained by the command resolving module 502, obtains by inquiring the network address and the port number that are corresponding to the household electrical appliance ID from the saved household electrical appliance information list, and judges whether the household electrical appliance ID is an effective ID and whether the controlling command is an effective controlling command. If one of the appliance ID and the controlling command is ineffective, the module performs no processing, and directly sends the feedback information (for example, that the household electrical appliance ID is ineffective) to the smart watch side via the connection controlling module 501. If they are both effective, the module, according to the network address and the port number that are corresponding to the household electrical appliance ID, sends the controlling command and its parameters to the corresponding household electrical appliance to execute the corresponding controlling command, to realize the controlling function.

Optionally, the household electrical appliance controlling module 503 may also return the current condition information of the household electrical appliance to the connection controlling module 501, and send the feedback information to the smart watch controlling side via the connection controlling module 501.

FIG. 6 is the work flow chart of the smart home controlling server of another embodiment of the present disclosure. Referring to FIG. 6, in the present embodiment, the control process of the smart home controlling server comprises the following Step S61 to Step S66:

Step S61, monitoring and receiving the controlling message of the smart watch side, and then entering Step S62.

The embodiment receives the controlling message that is wirelessly sent by the smart watch. Specially, the smart home controlling server establishes a wireless connection with the smart watch side, such as Bluetooth Low Energy BLE, monitors the connection condition, and acquires the controlling message that is sent by the smart watch side.

Step S62, obtaining the household electrical appliance ID and the controlling command by resolving, and then entering Step S63.

In the present step, the embodiment resolves the controlling message, to obtain the household electrical appliance information and the controlling command. Specially, the embodiment resolves the received controlling message to obtain the household electrical appliance ID and the controlling command.

Step S63, inquiring the address and the port number of the household electrical appliance according to the ID, and then entering Step S64.

In the present step the embodiment looks up the corresponding household electrical appliance according to the household electrical appliance information. Specially, the embodiment inquires the network address and the port number of the household electrical appliance that is corresponding to the household electrical appliance ID in the household electrical appliance information list that is in advance saved according to the household electrical appliance ID that is obtained by resolving in Step S62.

Step S64, judging whether they are effective household electrical appliance IDs and effective controlling commands, and if yes, entering Step S65, and if no, entering Step S66.

Optionally, the present embodiment further comprises an operation of judging whether the household electrical appliance ID and the controlling command that are obtained by resolving are effective. For example, the present embodiment looks up in the household electrical appliance information list that is in advance saved whether the ID that is obtained by resolving exists, and if yes, determines that the household electrical appliance ID that is obtained by resolving is effective, and if not, determines that the household electrical appliance ID that is obtained by resolving is ineffective. If the household electrical appliance ID is ineffective, the smart home controlling server may return corresponding information (for example, information that the household electrical appliance ID is ineffective) to the smart watch side, to remind the smart watch side to confirm the household electrical appliance ID that is sent.

Step S65, sending the controlling command to the designated household electrical appliance.

According to the network address and the port number of the household electrical appliance that are corresponding to the household electrical appliance ID that is inquired in Step S63, the embodiment sends the controlling command to the corresponding household electrical appliance to execute, to realize the controlling on the condition of the household electrical appliance.

Step S66, sending feedback information to the smart watch side.

After the controlling on the household electrical appliance is completed, the smart home controlling server may acquire the execution result from the household electrical appliance, and feedback the execution result to the smart watch side, so that the smart watch side can according to the feedback information output corresponding reminder information to remind the wearer. For example, the smart watch controls a built-in vibrating motor to emit a vibration of a preset frequency to remind the wearer that the household electrical appliance controlling is successful or fails.

### The Fourth Embodiment

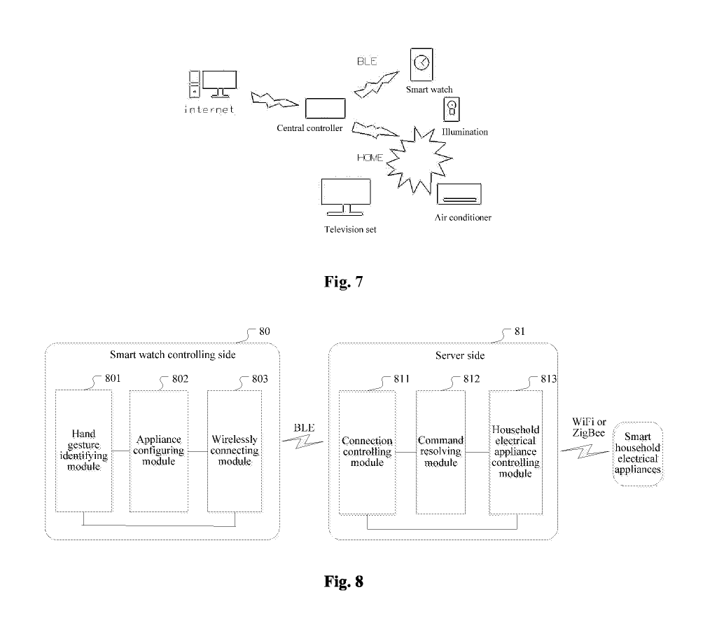

FIG. 7 is the network structure diagram of the system for controlling a smart home of an embodiment of the present disclosure. FIG. 8 is the structural block diagram of the system for controlling a smart home of an embodiment of the present disclosure. The present embodiment mainly describes the structure of the smart home controlling server by referring to FIG. 7 and FIG. 8, and the other contents can be seen in the other embodiments of the present disclosure.

Referring to FIG. 7, the system for controlling a smart home comprises a smart home controlling server (that is, the computer shown in FIG. 7), and a plurality of smart household electrical appliances (a television set, an air conditioner and an electric lamp) that are wirelessly connected with the smart home controlling server. In the procedure of practical applications, a central controller of the household electrical appliances can be installed inside the home, wherein the central controller is connected with the smart home controlling server by network.

The smart household electrical appliances are connected with the smart home controlling server by wireless modes such as Wi-Fi or ZigBee, which forms an internal in-house network, and are controlled, coordinated and managed in a centralized way by the smart home controlling server. In order to facilitate the controlling operation on the smart household electrical appliances by the user, the system for controlling a smart home of the present embodiment realizes that by the wearer of the smart watch executing certain hand gesture actions.

Referring to FIG. 7, within the home network, the smart watch establishes the connection with the smart home controlling server by BLE wireless mode, acquires the data that are to be identified by using the MEMS sensor in the smart watch, identifies the hand gesture action that is made by the user by using an identifying algorithm, and on the basis of the hand gesture action generates a corresponding controlling command to the smart home controlling server. Then, the smart home controlling server, according to the received hand gesture controlling command, realizes performing corresponding controlling on the matched household electrical appliance.

As shown in FIG. 8, the system for controlling a smart home comprises: a smart watch controlling side 80, a server side (that is, the smart home controlling server) 81, and the smart household electrical appliances that are wirelessly connected with the server side, wherein, the smart watch controlling side 80 comprises a hand gesture identifying module 801, an appliance configuring module 802 and a wirelessly connecting module 803, and the smart home controlling server 81 comprises a connection controlling module 811, a command resolving module 812 and a household electrical appliance controlling module 813.

The hand gesture identifying module 801 of the smart watch controlling side 80 is specifically for collecting characteristic data to be identified of a wearer by the sensor, and identifying out a current hand gesture action of the wearer. The appliance configuring module 802 is for by using correspondence relations that are in advance saved between corresponding hand gesture actions and controlling commands of household electrical appliances, matching the current hand gesture action, and generating a controlling message according to matched household electrical appliance information and the controlling command. The wirelessly connecting module 803 is for wirelessly sending the generated controlling message to a smart home controlling server 81.

The connection controlling module 811 of the smart home controlling server 81 is for establishing a wireless connection with the smart watch, receiving the controlling message that is sent by the smart watch, and sending the controlling message to the command resolving module 812. The command resolving module 812 is for resolving the received controlling message, and sending the household electrical appliance information and controlling command that is obtained by resolving, to the household electrical appliance controlling module 813. The household electrical appliance controlling module 813 is for according to the received household electrical appliance information, looking up the corresponding household electrical appliance, and sending the controlling command to the household electrical appliance to execute, to realize the controlling on the condition of the household electrical appliance.

It should be noted that, the detailed working process of the smart watch side and the detailed working process of the smart home controlling server of the system for controlling a smart home of the embodiments of the present disclosure can be seen in the relevant descriptions of the other embodiments of the present disclosure, and will not be in detail described here.

In conclusion, the technical solutions of the embodiments of the present disclosure control household electrical appliances by using a wearable device, and accordingly the wearer of the wearable device merely needs to execute certain hand gesture actions to perform convenient and intuitive controlling on different household electrical appliances, which avoids the relatively tedious controlling modes caused by smart phones and other devices. In addition, the wearable device has a built-in MEMS sensor, and such hand gesture identification that is on the basis of the MEMS sensor is flexible and reliable, is not affected by environment and light, and has a system that is simply implemented.

In addition, the wearable device is generally worn on the user for a long time, and the wearer can give different controlling commands by executing the hand gesture actions at any time, to more conveniently realize the interaction between the wearer and the household electrical appliances, without looking for and using control terminals such as remote controller and smart phone, which, compared with the traditional controlling modes, saves the time, promotes the efficiency, and enhances the user experience.

Furthermore, the technical solutions of the present embodiment improve hand gesture action identification, and reduce the original acceleration signal to one dimension by using principal components analysis PCA, which, compared with the hand gesture identification of the prior art which performs the operations directly on the three-dimensional data, reduces the calculation complexity. In addition, because the technical solutions perform action identification and matching after the dimension reduction processing of the original three-dimensional data, the solution reduces the requirements on the gesture when the user is executing the hand gesture actions, so that the user can execute the hand gesture actions relatively freely.

The above descriptions are merely preferable embodiments of the present disclosure, and are not limiting the protection scope of the present disclosure. Any modifications, equivalent substitutions or improvements that are made within the spirit and principle of the present disclosure are all included in the protection scope of the present disclosure.

1. A wearable device, wherein, the wearable device comprises: a hand gesture identifying module, a wirelessly connecting module and an appliance configuring module;
the hand gesture identifying module is for by characteristic data to be identified of a wearer that is collected by a sensor, identifying out a current hand gesture action of the wearer, and sending information of the hand gesture action to the appliance configuring module;
the appliance configuring module is for according to acquired information of each of household electrical appliances, establishing and saving correspondence relations between controlling commands of each of the household electrical appliances and corresponding hand gesture actions; and, for upon receiving the information of the hand gesture action sent by the hand gesture identifying module, looking up the household electrical appliance and the controlling command that match the hand gesture action by using the saved correspondence relations, generating a controlling message according to the matched household electrical appliance and controlling command, and sending the generated controlling message to the wirelessly connecting module; and
the wirelessly connecting module is for receiving the controlling message that is sent by the appliance configuring module and wirelessly sending the controlling message to a smart home controlling server, so that the smart home controlling server controls the condition of the household electrical appliance according to the controlling message.

2. The wearable device according to claim 1, wherein,
the appliance configuring module is provided with information of a default hand gesture action;
the appliance configuring module is for establishing and saving correspondence relations between the controlling command of each of the household electrical appliances and the default hand gesture action;
or, the appliance configuring module is for receiving information of an optional hand gesture action that is inputted by the wearer by an interaction interface of the wearable device, and establishing and saving correspondence relations between the controlling command of each of the household electrical appliances and the optional hand gesture action.

3. The wearable device according to claim 2, wherein, the appliance configuring module sets the correspondence relations between the controlling command of each of the household electrical appliances and the default hand gesture action specifically by the following way:
corresponding a hand gesture action of drawing a rectangle in a clockwise direction and a hand gesture action of drawing a rectangle in a counter-clockwise direction respectively to a turning-on controlling command and a turning-off controlling command of the household electrical appliance of a first type;
corresponding a hand gesture action of drawing a circle in a clockwise direction and a hand gesture action of drawing a circle in a counter-clockwise direction respectively to a turning-on controlling command and a turning-off controlling command of the household electrical appliance of a second type; and
corresponding a hand gesture action of drawing a broken line in a top-to-bottom direction and a hand gesture action of drawing a broken line in a bottom-to-top direction respectively to a turning-on controlling command and a turning-off controlling command of the household electrical appliance of a third type.

4. The wearable device according to claim 1, wherein,
the wirelessly connecting module is further for upon connecting to the smart home controlling server for the first time, sending registration information of the wearable device and identity information of the wearer to the smart home controlling server, so that the smart home controlling server verifies the wearable device and the wearer; and
for upon, after the verification is successfully completed, connecting to the smart home controlling server again, sending logging-in information to the smart home controlling server.

5. The wearable device according to claim 1, wherein,
the hand gesture identifying module is specifically for collecting a three-axis acceleration data sequence or a three-axis angular velocity data sequence that is to be identified of the wearer by using a three-axis acceleration sensor or a three-axis angular velocity sensor;
performing characteristic extraction on the three-axis acceleration data sequence or the three-axis angular velocity data sequence by using principal components analysis, and reducing a data dimension number of the three-axis acceleration data sequence or the three-axis angular velocity data sequence to one dimension; and
comparing the one-dimensional acceleration data sequence or one-dimensional angular velocity data sequence of which the data dimension has been reduced, with a corresponding template characteristic data sequence, to identify out the current hand gesture action of the wearer; wherein, the template characteristic data sequence comprises an acceleration template data sequence and an angular velocity template data sequence, and a data dimension number of the acceleration template data sequence and a data dimension number of the angular velocity template data sequence are one dimension.

6. The wearable device according to claim 2, wherein,
the appliance configuring module is for receiving an instruction of adding or deleting a household electrical appliance selected by the wearer in a household electrical appliance information list that is presented on the interaction interface of the wearable device, and establishing and saving a correspondence relation between the controlling command of the added household electrical appliance and a hand gesture action according to the adding instruction of the wearer; or, releasing and saving a correspondence relation between the controlling command of the deleted household electrical appliance and the hand gesture action according to the deleting instruction of the wearer

7. A system for controlling a smart home, wherein, the system for controlling a smart home comprises:
the wearable device according to claim 1, a smart home controlling server, and, a plurality of household electrical appliances that are wirelessly connected with the smart home controlling server; and
the wearable device on the basis of a hand gesture action of the user sends a controlling command to the smart home controlling server, and the smart home controlling server sends the controlling command to each of the household electrical appliances by a wireless connection, thereby realizing the controlling on each of the household electrical appliances.

8. The system for controlling a smart home according to claim 7, wherein, the smart home controlling server comprises: a connection controlling module, a command resolving module and a household electrical appliance controlling module;
the connection controlling module is for establishing a wireless connection with the wearable device, receiving a controlling message sent by the wearable device, and sending the controlling message to the command resolving module;
the command resolving module is for resolving the received controlling message, and sending the household electrical appliance information obtained by resolving and the controlling command, to the household electrical appliance controlling module; and
the household electrical appliance controlling module is for looking up the corresponding household electrical appliance according to the received household electrical appliance information, and sending the controlling command to the household electrical appliance to execute, thereby realizing the controlling on the condition of the household electrical appliance.

9. The system for controlling a smart home according to claim 8, wherein, the command resolving module is for resolving out a unique identification ID of the household electrical appliance from the received controlling message, and sending the household electrical appliance ID obtained by resolving and the controlling command to the household electrical appliance controlling module; and
the household electrical appliance controlling module is for after the household electrical appliance ID and the controlling command are received, looking up in a saved household electrical appliance information list whether the household electrical appliance ID exists; and if yes, sending the controlling command to the household electrical appliance that is corresponding to the household electrical appliance ID to execute; and
receiving an execution result that is fed back by the household electrical appliance, and sending the execution result via the connection controlling module to the wearable device, so that the wearable device according to the execution result outputs reminder information to the user.

10. A method for controlling a wearable device, wherein, the wearable device is provided with a sensor, and the method comprises:
collecting characteristic data to be identified of a wearer by the sensor, and identifying out a current hand gesture action of the wearer;
by using correspondence relations that are in advance saved between corresponding hand gesture actions and controlling commands of household electrical appliances, matching the current hand gesture action, and generating a controlling message according to information of a matched household electrical appliance and the controlling command; and
wirelessly sending the generated controlling message to a smart home controlling server, so that the smart home controlling server controls the condition of the household electrical appliance according to the controlling message.

11. The method according to claim 10, wherein, the sensor is a three-axis acceleration sensor or a three-axis angular velocity sensor; and
the collecting characteristic data to be identified of a wearer by the sensor, and identifying out a current hand gesture action of the wearer comprises:
collecting a three-axis acceleration data sequence or a three-axis angular velocity data sequence that is to be identified of the wearer by using a three-axis acceleration sensor or a three-axis angular velocity sensor;
performing characteristic extraction on the three-axis acceleration data sequence or the three-axis angular velocity data sequence by using principal components analysis, and reducing a data dimension number of the three-axis acceleration data sequence or the three-axis angular velocity data sequence to one dimension; and
comparing the one-dimensional acceleration data sequence or one-dimensional angular velocity data sequence of which the data dimension has been reduced, with a corresponding template characteristic data sequence, and identifying out a current hand gesture action of the wearer; wherein, the template characteristic data sequence comprises an acceleration template data sequence and an angular velocity template data sequence, and a data dimension number of the acceleration template data sequence and a data dimension number of the angular velocity template data sequence are one dimension.

12. The method according to claim 10, wherein, the corresponding hand gesture actions comprise: a default hand gesture action and an optional hand gesture action;
the correspondence relation between the optional hand gesture action and the controlling command of the household electrical appliances is set by the following way:
receiving the optional hand gesture action that is inputted by the user on an interaction interface of the wearable device, and establishing the correspondence relation between the optional hand gesture action and a controlling command of the household electrical appliances; and
the method comprises: setting the correspondence relations between the default hand gesture actions and the controlling commands of the household electrical appliances by the following way:
corresponding a hand gesture action of drawing a rectangle in a clockwise direction and a hand gesture action of drawing a rectangle in a counter-clockwise direction respectively to a turning-on controlling command and a turning-off controlling command of the household electrical appliance of a first type;
corresponding a hand gesture action of drawing a circle in a clockwise direction and a hand gesture action of drawing a circle in a counter-clockwise direction respectively to a turning-on controlling command and a turning-off controlling command of the household electrical appliance of a second type; and
corresponding a hand gesture action of drawing a broken line in a top-to-bottom direction and a hand gesture action of drawing a broken line in a bottom-to-top direction respectively to a turning-on controlling command and a turning-off controlling command of the household electrical appliance of a third type.

13. The method according to claim 10, wherein, the method further comprises:
upon connecting to the smart home controlling server for the first time, sending registration information of the wearable device and identity information of the wearer to the smart home controlling server, so that the smart home controlling server verifies the wearable device and the wearer; and
upon, after the verification is successfully completed, connecting to the smart home controlling server again, sending a logging-in information to the smart home controlling server.

14. The method according to claim 10, wherein, the method further comprises: setting the correspondence relation between a corresponding hand gesture action and the controlling command of the household electrical appliances by the following way:
receiving an instruction of adding or deleting a household electrical appliance selected by the wearer in a household electrical appliance information list that is presented on an interaction interface of the wearable device, and establishing a correspondence relation between the controlling command of the added household electrical appliance and a hand gesture action according to the adding instruction of the wearer; or, releasing a correspondence relation between the controlling command of the deleted household electrical appliance and the hand gesture action according to a deleting instruction of the wearer.
